(19) United States
(12) Patent Application Publication
(10) Pub. No.: US 2008/0012413 A1
(43) Pub. Date: Jan. 17, 2008

(54) Seat Adjustment Mechanism Comprising a Rotative Actuating Element

(76) Inventors: Ruediger Schneiss, Seesbach (DE); Klaus Freitag, Bad Kreuznach (DE)

Correspondence Address: DELPHI TECHNOLOGIES, INC., M/C 480-410-202, PO BOX 5052, TROY, MI, 48007, US

(21) Appl. No.: 11/667,408

(22) PCT Filed: Nov. 18, 2005
(86) PCT No.: PCT/DE05/02077

§ 371 Date: May 9, 2007

(30) Foreign Application Priority Data
Nov. 20, 2004 (DE) 10 2004 056 77.3

(51) Int. Cl. B60N 2/02

(52) U.S. Cl. 297/354.11

(57) ABSTRACT

The invention relates to a seat adjustment mechanism comprising at least one rotative actuating element (1,6), which is allocated to a vehicle seat (5) comprising a seat surface (4) and a backrest (3) that is connected to said surface by means of an articulation (2). The actuating element (1, 6) is located in the vicinity of the articulation (2) on the exterior of the vehicle seat (5), or in the vicinity of a front outer corner of said seat (5).

The invention relates to a seat-adjusting switch with at least one rotatable actuating element which is associated with a vehicle seat with a seat surface and a seat back arranged thereon via a hinge.

In particular motor vehicles are to an increasing extent being fitted out with adjustable motor vehicle seats which allow adaptation to the body of a vehicle user for travel without fatigue. Originally, there was only provision for longitudinal adjustment of the motor vehicle seat and tilt adjustment of the seat back by means of corresponding mechanical devices, wherein for tilt adjustment of the seat back in the region of a hinge connecting the seat surface to the seat back there is an adjusting knob which can be acted upon rotatably. In the case of newer developments of motor vehicle seats, in addition to the above-mentioned adjustment facilities, changes in the seat height, and adjustments of the headrest and lumbar support by means of servo motors are made possible. To control the different servo motors a corresponding number of electrical switches which are combined into so-called seat-adjusting switches is necessary.

EP 1 178 897 B1 discloses a control device for the control of servo motors for the adjustment of different seat parts of a seat with at least two switches for the seat-adjusting movements to be performed, one switch being designed as a selector switch for different switching menus of the region of adjustment of the seat parts and the other switch being designed as a multi-function switch for the adjusting movements of the respective region of adjustment of the seat part. The multi-function switch is a sliding/rotary switch which can be acted upon crosswise and with which are associated in each switching menu horizontal and/or vertical adjusting movements as well as tilt adjusting movements for the selected region of adjustment of the seat part. With this control device, it is problematic insofar as the vehicle driver must first actuate the selector switch and performs the adjusting movements of the respective regions of adjustment of the seat part by acting on the multi-function switch. As this control device as a rule is arranged in the outer lateral region of the seat surface of the motor vehicle seat, the vehicle driver must find the individual switches by fumbling, as a result of which his attention is diverted from what is going on with the traffic.

Furthermore, from WO 97/04985 A is known a control device with a control unit for the control of servo motors for the adjustment of different seat parts of a motor vehicle seat. The control unit, which is arranged in the vicinity of a steering wheel of the motor vehicle, includes several individual switches which are designed as rotary, sliding or pushbutton switches and of which a first individual switch serves to activate a stored position of the seat parts. With a second individual switch designed as a selector switch, the associated servo motors are activated selectively and controlled by means of further individual switches. In order to display visually the adjusting movements controlled with the individual switches, a screen with clear pictograms is associated with the control unit. The control unit has an elaborate and therefore expensive structure.

It is the object of the invention to provide a seat-adjusting switch of the kind mentioned hereinbefore, whose actuating element is placed on a vehicle seat in such a way that a vehicle driver intuitively detects the adjustments of the seat to be performed with the actuating element, the seat-adjusting switch having a simple and cheap structure.

According to the invention, the object is achieved by the fact that the actuating element is arranged in the region of the hinge on the outside of the vehicle seat.

In the region of the hinge between the seat surface and the seat back is usually arranged a mechanical adjusting wheel for tilt adjustment of the seat back, which is why vehicle drivers as a rule seek in this location after an actuating element with which they can adjust the tilt of the seat back. By arranging the actuating element of the electrical seat-adjusting switch in this location, the driver intuitively detects the facility to perform adjustments of the seat back, which is why both operation of the seat-adjusting switch is facilitated and road safety is increased, as the driver's attention is not diverted from what is going on with the traffic by searching by feel or acting on several individual switches.

Appropriately, the actuating element serves to control adjustment functions associated with the seat back. Preferably, a rotary shaft of the actuating element is aligned coaxially with a hinge pin. In order to be able to perform a plurality of adjustment functions on the seat back with the actuating element, the actuating element is advantageously mounted so as to be slidable crosswise. To increase the convenience of operation of the seat-adjusting switch, in an embodiment the actuating element can be acted upon by feel.

According to a development, upon a rotary movement of the actuating element out of a neutral position in one or the other direction a clearly associated tilt adjustment of the seat back takes place. If a user of the vehicle seat rotates the actuating element in the direction towards the front of the vehicle, the seat back is tilted forwards, and upon a rotary movement in the direction of the rear of the vehicle the seat back is tilted backwards. In a further embodiment, upon a vertical displacement of the actuating element out of the neutral position in one or the other direction a corresponding height adjustment of a headrest takes place. Appropriately, a horizontal displacement of the actuating element out of the neutral position in one or the other direction causes a clearly associated adjustment of a lumbar support. Hence the essential adjustments in the region of the seat back can be performed via the actuating element.

In order to be able to perform further adjustments in the region of the seat back, advantageously the actuating element is ring-shaped and at its centre receives a rocker switch. Appropriately, the rocker switch can be acted upon crosswise. By means of the rocker switch, firstly adjustments of the lumbar support and secondly width adjustments of the seat back can be performed.

Furthermore, the object is also achieved according to the invention by the fact that the actuating element is arranged in the region of a front outer corner of the vehicle seat.

On account of the positioning of the actuating element, its function is likewise easy for the user of the vehicle seat to detect intuitively. To perform certain adjustments, the user of the vehicle seat reaches into this region in order to search for an actuating element by feel.

Preferably, the actuating element serves to control adjustment functions associated with the vehicle seat and/or the seat surface.

Appropriately, the actuating element is mounted so as to be slidable crosswise. Preferably the actuating element is ring-shaped and has at its centre a button. Thus by means of the actuating element a plurality of adjustment functions associated with the vehicle seat and/or the seat surface can be performed, the actuating element having a compact structure, which reduces the manufacturing and stock-keeping costs.

Preferably, by felt rotation of the actuating element out of its neutral position in one or the other direction a clear tilt adjustment of the seat surface takes place. According to a development, felt horizontal sliding of the actuating element out of a neutral position in one or the other direction causes a corresponding adjusting movement of the whole vehicle seat. Advantageously, felt vertical sliding of the actuating element out of a neutral position in one or the other direction causes a corresponding height adjustment of the vehicle seat. In an embodiment, upon a felt action on the rocker switch out of the neutral position in one or the other direction a corresponding adjustment of the depth of the seat surface takes place.

It goes without saying that the characteristics mentioned above and yet to be described below can be used not only in the given combination, but also in other combinations. The scope of the invention is defined only by the claims.

The invention is described in more detail below with the aid of a practical example with reference to the associated drawings. They show:

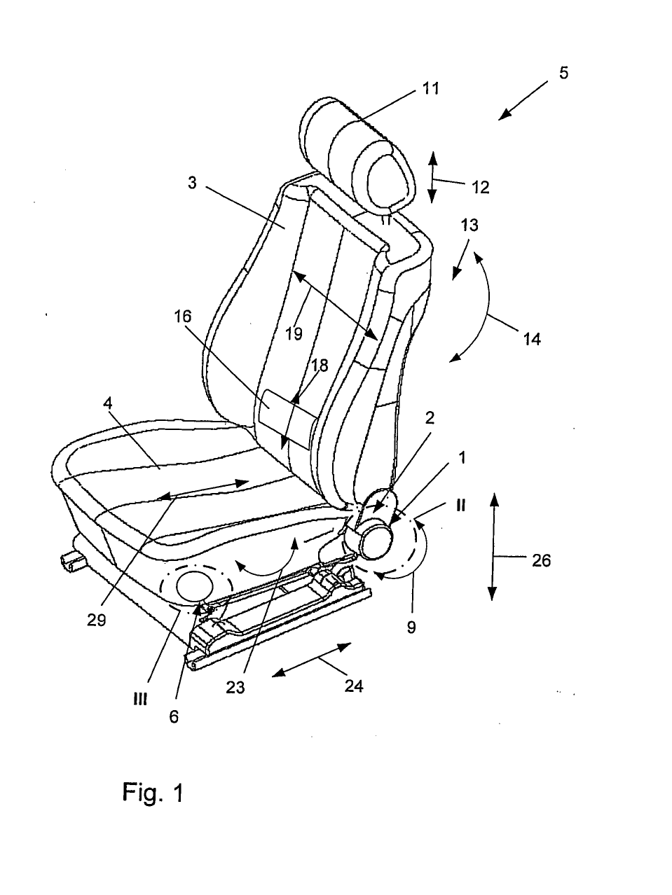

FIG. 1 a perspective view of a vehicle seat whose seat parts are adjustable by means of the seat-adjusting switch according to the invention,

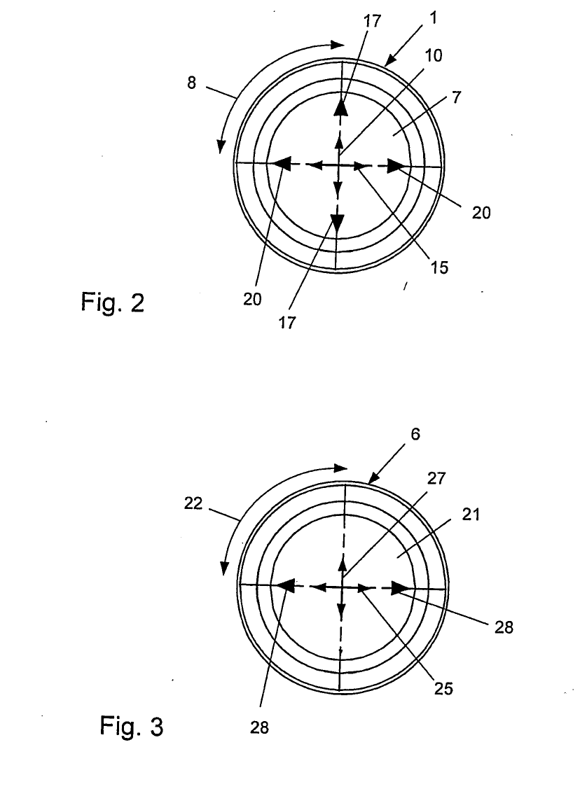

FIG. 2 an enlarged view of detail II as in FIG. 1 and

FIG. 3 an enlarged view of detail III as in FIG. 1.

The seat-adjusting switch which comprises a plurality of individual switches for the control of servo motors essentially includes an actuating element 1 which is arranged on the outside of a vehicle seat 5 in the region of a hinge 2 by which a seat back 3 is connected to a seat surface 4. Furthermore, an actuating element 6 of a seat-adjusting switch, which is placed in the region of a front outer corner of the vehicle seat 5, is provided.

The round actuating element 1 which can be acted upon so as to rotate and slide crosswise is oriented with its rotary shaft coaxial with a hinge pin and serves to control adjustment functions associated with the seat back 3, the actuating element 1 being ring-shaped for the control of a plurality of adjustment functions and receiving at its centre a rocker switch 7 which can be acted upon crosswise. Upon a felt rotary movement of the actuating element 1 out of a neutral position in one or the other direction according to double arrow 8, a clearly associated tilt adjustment according to double arrow 9 of the seat back 3 takes place. After release of the actuating element 1, the latter returns to its neutral position and the seat back 3 remains in its current position. By vertical sliding of the actuating element 1, also felt, out of the neutral position in one or the other direction according to double arrow 10, servo motors for a headrest 11 mounted in the seat back 3 perform a height adjustment thereof according to double arrow 12 corresponding to the direction of action on the actuating element 1. To pivot a head region 13 of the seat back 3 according to the double arrow 14, the actuating element 13 is slid by feel horizontally out of its neutral position in one or the other direction according to double arrow 15. A lumbar support 16 integrated in the seat back 3 is adjusted according to the double arrow 18 by actuation of the rocker switch 7 according to the arrows 17. To adjust the width of the seat back 3 according to the double arrow 19, the rocker switch 7 is acted upon by feel in the direction of the arrows 20.

The actuating element 6 which serves to control the actuation functions associated with the vehicle seat 5 or seat surface 4 is also mounted so as to be slidable crosswise by feel and is ring-shaped and at its centre receives a rocker switch 21. Upon felt rotation of the actuating element 6 out of its neutral position in one or the other direction according to double arrow 22, tilting of the seat surface 4 according to double arrow 23 is performed clearly by means of corresponding switches with associated servo motors. To obtain a vertical adjusting movement of the whole vehicle seat 5 according to the double arrow 24, the actuating element 6 is slid out of its neutral position horizontally in one or the other direction according to double arrow 25. To accomplish height adjustment of the whole vehicle seat 5 according to the double arrow 26, the actuating element 6 is slid by feel out of its neutral position vertically in one or the other direction according to the double arrow 27. By felt action on the rocker switch 21 out of the neutral position in one or the other direction according to the arrows 28, a corresponding adjustment of the depth of the seat surface 4 is performed according to the double arrow 29.

1. Seat-adjusting switch with at least one rotatable actuating element (1) which is associated with a vehicle seat (5) with a seat surface (4) and a seat back (3) arranged thereon via a hinge (2), characterised in that the actuating element (1) is arranged in the region of the hinge (2) on the outside of the vehicle seat (5).

2. Seat-adjusting switch according to claim 1, characterised in that the actuating element (1) serves to control adjustment functions associated with the seat back (3).

3. Seat-adjusting switch according to claim 1 or 2, characterised in that a rotary shaft of the actuating element (1) is aligned coaxially with a hinge pin.

4. Seat-adjusting switch according to any of claims 1 to 3, characterised in that the actuating element (1) is mounted so as to be slidable crosswise.

5. Seat-adjusting switch according to any of claims 1 to 4, characterised in that the actuating element (1) can be acted upon by feel.

6. Seat-adjusting switch according to any of claims 1 to 5, characterised in that upon a rotary movement of the actuating element (1) out of a neutral position in one or the other direction a clearly associated tilt adjustment of the seat back (3) takes place.

7. Seat-adjusting switch according to any of claims 4 to 6, characterised in that upon vertical sliding of the actuating element (1) out of the neutral position in one or the other direction a corresponding height adjustment of a headrest (11) takes place.

8. Seat-adjusting switch according to any of claims 4 to 7, characterised in that horizontal sliding of the actuating element (1) out of the neutral position in one or the other direction causes a clearly associated adjustment of a head region (13) of the seat back (3).

9. Seat-adjusting switch according to any of claims 1 to 8, characterised in that the actuating element (1) is ring-shaped and at its centre receives a rocker switch (7).

10. Seat-adjusting switch according to claim 9, characterised in that the rocker switch (7) can be acted upon crosswise.

11. Seat-adjusting switch according to the introductory part of claim 1, characterised in that the actuating element (6) is arranged in the region of a front outer corner of the vehicle seat (5).

12. Seat-adjusting switch according to claim 11, characterised in that the actuating element (6) serves to control adjustment functions associated with the vehicle seat (5) and/or the seat surface (4).

13. Seat-adjusting switch according to claim 11 or 12, characterised in that the actuating element (6) is mounted so as to be slidable crosswise.

14. Seat-adjusting switch according to any of claims 11 to 13, characterised in that the actuating element (6) is ring-shaped and at its centre receives a rocker switch (21).

15. Seat-adjusting switch according to any of claims 11 to 14, characterised in that by felt rotation of the actuating element (6) out of its neutral position in one or the other direction a clear tilt adjustment of the seat surface (4) takes place.

16. Seat-adjusting switch according to any of claims 11 to 15, characterised in that horizontal felt sliding of the actuating element (6) out of its neutral position in one or the other direction causes a corresponding adjusting movement of the whole vehicle seat (5).

17. Seat-adjusting switch according to any of claims 11 to 16, characterised in that vertical felt sliding of the actuating element (6) out of its neutral position in one or the other direction causes a corresponding height adjustment of the vehicle seat (5).

18. Seat-adjusting switch according to any of claims 11 to 17, characterised in that upon a felt action on the rocker switch (21) out of the neutral position in one or the other direction a corresponding adjustment of the depth of the seat surface (4) takes place.
